(19) United States
(12) Patent Application Publication
(10) Pub. No.: US 2025/0373768 A1
(43) Pub. Date: Dec. 4, 2025

(54) ONLINE RECTIFICATION OF SEE-THROUGH CAMERA PAIR

(71) Applicant: Samsung Electronics Co., Ltd., Suwon-si (KR)

(72) Inventors: Yingen Xiong, Mountain View, CA (US); Christopher A. Peri, Mountain View, CA (US)

(21) Appl. No.: 19/212,446

(22) Filed: May 19, 2025

Related U.S. Application Data
(60) Provisional application No. 63/654,748, filed on May 31, 2024.

(51) Int. Cl. H04N 13/111; G06T 7/33; G06T 7/80; H04N 13/00; H04N 13/156; H04N 13/366

(52) U.S. Cl. CPC H04N 13/111; G06T 7/33; G06T 7/85; H04N 13/156; H04N 13/366; G06T 2207/20228; H04N 2013/0081

(57) ABSTRACT

A method includes obtaining, using multiple imaging sensors of an electronic device, a left image frame and a right image frame forming a stereo pair of image frames. The method also includes identifying, using at least one processing device of the electronic device, extrinsic parameters associated with relative positions and orientations of the imaging sensors. The method further includes performing, using the at least one processing device, an online stereo rectification of the stereo pair of image frames based on the extrinsic parameters such that epipolar lines of the left and right image frames are horizontally aligned to generate a rectified stereo pair of image frames. In addition, the method includes rendering, using the at least one processing device, one or more images for display based on the rectified stereo pair of image frames.

### CROSS-REFERENCE TO RELATED APPLICATION AND PRIORITY CLAIM

This application claims priority under 35 U.S.C. § 119 (e) to U.S. Provisional Patent Application No. 63/654,748 filed on May 31, 2024, which is hereby incorporated by reference in its entirety.

### TECHNICAL FIELD

This disclosure relates generally to image processing systems and processes. More specifically, this disclosure relates to online rectification of a see-through camera pair.

### BACKGROUND

Extended reality (XR) systems are becoming more and more popular over time, and numerous applications have been and are being developed for XR systems. Some XR systems (such as augmented reality or “AR” systems and mixed reality or “MR” systems) can enhance a user's view of his or her current environment by overlaying digital content (such as information or virtual objects) over the user's view of the current environment. For example, some XR systems can often seamlessly blend virtual objects generated by computer graphics with real-world scenes.

### SUMMARY

This disclosure relates to online rectification of a see-through camera pair.

In a first embodiment, a method includes obtaining, using multiple imaging sensors of an electronic device, a left image frame and a right image frame forming a stereo pair of image frames. The method also includes identifying, using at least one processing device of the electronic device, extrinsic parameters associated with relative positions and orientations of the imaging sensors. The method further includes performing, using the at least one processing device, an online stereo rectification of the stereo pair of image frames based on the extrinsic parameters such that epipolar lines of the left and right image frames are horizontally aligned to generate a rectified stereo pair of image frames. In addition, the method includes rendering, using the at least one processing device, one or more images for display based on the rectified stereo pair of image frames.

In a second embodiment, an apparatus includes multiple imaging sensors configured to obtain a left image frame and a right image frame forming a stereo pair of image frames. The apparatus also includes at least one processing device configured to identify extrinsic parameters associated with relative positions and orientations of the imaging sensors, perform an online stereo rectification of the stereo pair of image frames based on the extrinsic parameters such that epipolar lines of the left and right image frames are horizontally aligned to generate a rectified stereo pair of image frames, and render one or more images for display based on the rectified stereo pair of image frames.

In a third embodiment, a non-transitory machine readable medium contains instructions that when executed cause at least one processor of an electronic device to obtain a left image frame and a right image frame forming a stereo pair of image frames using multiple imaging sensors. The non-transitory machine readable medium also contains instructions that when executed cause the at least one processor to identify extrinsic parameters associated with relative positions and orientations of the imaging sensors. The non-transitory machine readable medium further contains instructions that when executed cause the at least one processor to perform an online stereo rectification of the stereo pair of image frames based on the extrinsic parameters such that epipolar lines of the left and right image frames are horizontally aligned to generate a rectified stereo pair of image frames. In addition, the non-transitory machine readable medium contains instructions that when executed cause the at least one processor to render one or more images for display based on the rectified stereo pair of image frames.

Any one or any combination of the following features may be used with the first, second, or third embodiment. The extrinsic parameters may be identified by identifying a common image feature in the left and right image frames; extracting left and right image features associated with the common image feature from the left and right image frames; determining if the left and right image features match; in response to a determination that the left and right image features match, obtaining a feature correspondence between the left and right image frames; optimizing an energy function associated with the feature correspondence; and identifying the extrinsic parameters based on the optimized energy function. The online stereo rectification may be performed by identifying first correspondence feature points using the extrinsic parameters; identifying second correspondence feature points using depth data associated with the stereo pair of image frames; determining that a difference between the first and second correspondence feature points is greater than a threshold; refining the extrinsic parameters by further optimizing the energy function based on the difference; and performing online stereo rectification of the rectified stereo pair of image frames based on the refined extrinsic parameters. The online stereo rectification may be performed by performing viewpoint matching by transforming the rectified stereo pair of image frames to match one or more user eye viewpoints and generate one or more viewpoint matched frames. The extrinsic parameters may include a rotation matrix and a translation vector. A transformation may be applied to the rectified stereo pair of image frames in order to generate one or more transformed image frames and the one or more transformed image frames may be rendered. The online stereo rectification may be performed automatically based on the extrinsic parameters or based on a user request.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit”, “receive”, and “communicate”, as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have”, “may have”, “include”, or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for”, “having the capacity to”, “designed to”, “adapted to”, “made to”, or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a”, “an”, and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a dryer, an air cleaner, a set-top box, a home automation control panel, a security control panel, a TV box (such as SAMSUNG HOMESYNC, APPLETV, or GOOGLE TV), a smart speaker or speaker with an integrated digital assistant (such as SAMSUNG GALAXY HOME, APPLE HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IoT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include any other electronic devices now known or later developed.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle. Use of any other term, including without limitation “mechanism”, “module”, “device”, “unit”, “component”, “element”, “member”, “apparatus”, “machine”, “system”, “processor”, or “controller” within a claim is understood by the Applicant to refer to structures known to those skilled in the relevant art and is not intended to invoke 35 U.S.C. § 112(f).

### BRIEF DESCRIPTION OF THE DRAWINGS

For a more complete understanding of this disclosure and its advantages, reference is now made to the following description taken in conjunction with the accompanying drawings, in which:

FIG. 1 illustrates an example network configuration including an electronic device in accordance with this disclosure;

FIG. 2 illustrates an example platform for offline see-through camera calibration and rectification;

FIG. 3 illustrates an example pipeline for online stereo rectification of a stereo pair of image frames in accordance with this disclosure;

FIG. 4 illustrates an example relationship between depth and image points in a stereo pair of image frames captured by imaging devices in accordance with this disclosure;

FIG. 5 illustrates an example diagram of online stereo rectification and viewpoint matching in accordance with this disclosure;

FIGS. 6A and 6B illustrate a raw stereo pair of image frames and a rectified stereo pair of image frames using online stereo rectification, respectively, in accordance with this disclosure; and

FIG. 7 illustrates an example method for online stereo rectification of a stereo pair of image frames in accordance with this disclosure.

### DETAILED DESCRIPTION

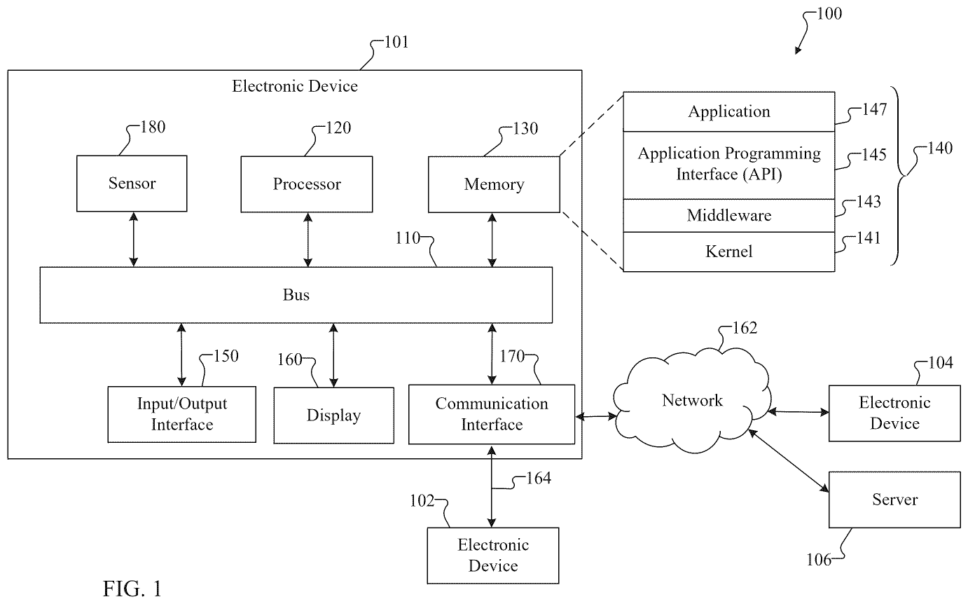

FIGS. 1 through 7, discussed below, and the various embodiments of this disclosure are described with reference to the accompanying drawings. However, it should be appreciated that this disclosure is not limited to these embodiments, and all changes and/or equivalents or replacements thereto also belong to the scope of this disclosure. The same or similar reference denotations may be used to refer to the same or similar elements throughout the specification and the drawings.

As noted above, extended reality (XR) systems are becoming more and more popular over time, and numerous applications have been and are being developed for XR systems. Some XR systems (such as augmented reality or “AR” systems and mixed reality or “MR” systems) can enhance a user's view of his or her current environment by overlaying digital content (such as information or virtual objects) over the user's view of the current environment. For example, some XR systems can often seamlessly blend virtual objects generated by computer graphics with real-world scenes.

Optical see-through (OST) XR systems refer to XR systems in which users directly view real-world scenes through head-mounted devices (HMDs). To improve user experience, a stereo pair of image frames needs to be rendered for display. Unfortunately, OST XR systems face many challenges that can limit their adoption. Some of these challenges include rendering a stereoscopic pairs to display panels. limited fields of view, limited usage spaces (such as indoor-only usage), failure to display fully-opaque black objects, and usage of complicated optical pipelines that may require projectors, waveguides, and other optical elements. In contrast to OST XR systems, video see-through (VST) XR systems (also called “passthrough” XR systems) present users with generated video sequences of real-world scenes. VST XR systems can be built using virtual reality (VR) technologies and can have various advantages over OST XR systems. For example, VST XR systems can provide wider fields of view and can provide improved contextual augmented reality.

A VST XR device often includes one or more imaging sensors (also called “see-through cameras”) that capture high-resolution image frames of a user's surrounding environment. These image frames are processed in an image processing pipeline in order to generate final rendered views of the user's surrounding environment. The user can view the rendered see-through frames to communicate with the surrounding environment. Since humans have binocular vision, a stereoscopic pair of image frames can be rendered to the display panels to ensure maximum user experience. However, generating a stereoscopic pair of image frames can be difficult. For example, optical axes of imaging sensors in a see-through camera pair installed on a VST XR headset may not be parallel. Thus, the captured image pair may not represent an actual stereoscopic pair. When an image pair rendered on display panels is not a stereoscopic pair, the user may feel uncomfortable while viewing the image pair on the panels. To ensure that the captured image pair is a stereoscopic image pair, the camera pair needs to be calibrated and rectified. Unfortunately, existing stereo calibration and rectification approaches often require the VST device to be physically forwarded to a specialized platform for offline stereo calibration and rectification, which is inconvenient and time-consuming.

This disclosure provides various techniques for online rectification of the see-through camera pair for video see-through extended reality. As described in more detail below, a stereo pair of image frames can be obtained using multiple imaging sensors. An online rectification of the stereo pair can be performed to obtain extrinsic parameters of the multiple imaging sensors. With the calibrated extrinsic parameters, the captured image frame pair is rectified to an accurate stereo pair. In this way, the disclosed techniques can be used to provide online stereo rectification on-the-fly without having to ship a VST device or other device to a specialized offline stereo rectification platform, thereby optimizing a user's experience.

FIG. 1 illustrates an example network configuration 100 including an electronic device in accordance with this disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, a processing device 120, a memory 130, an input/output (I/O) interface 150, a display 160, a communication interface 170, and a sensor 180. In some embodiments, the electronic device 101 may exclude at least one of these components or may add at least one other component. The bus 110 includes a circuit for connecting the components 120-180 with one another and for transferring communications (such as control messages and/or data) between the components.

The processing device 120 includes one or more processing devices, such as one or more microprocessors, microcontrollers, digital signal processors (DSPs), application specific integrated circuits (ASICs), or field programmable gate arrays (FPGAs). In some embodiments, the processing device 120 includes one or more of a central processing unit (CPU), an application processor (AP), a communication processor (CP), a graphics processor unit (GPU), or a neural processing unit (NPU). The processing device 120 is able to perform control on at least one of the other components of the electronic device 101 and/or perform an operation or data processing relating to communication or other functions. As described below, the processing device 120 may perform one or more functions related to online rectification of a stereo pair of image frames in XR or other applications.

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processing device 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 may include one or more applications that, among other things, perform online rectification of a stereo pair of image frames in XR or other applications. These functions can be performed by a single application or by multiple applications that each carries out one or more of these functions. The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the processing device 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user.

The communication interface 170, for example, is able to set up communication between the electronic device 101 and an external electronic device (such as a first electronic device 102, a second electronic device 104, or a server 106). For example, the communication interface 170 can be connected with a network 162 or 164 through wireless or wired communication to communicate with the external electronic device. The communication interface 170 can be a wired or wireless transceiver or any other component for transmitting and receiving signals.

The wireless communication is able to use at least one of, for example, WiFi, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a communication protocol. The wired connection can include, for example, at least one of a universal serial bus (USB), high definition multimedia interface (HDMI), recommended standard 232 (RS-232), or plain old telephone service (POTS). The network 162 or 164 includes at least one communication network, such as a computer network (like a local area network (LAN) or wide area network (WAN)), Internet, or a telephone network.

The electronic device 101 further includes one or more sensors 180 that can meter a physical quantity or detect an activation state of the electronic device 101 and convert metered or detected information into an electrical signal. For example, the sensor(s) 180 can include cameras or other imaging sensors, which may be used to capture image frames of scenes. The sensor(s) 180 can also include one or more buttons for touch input, one or more microphones, a depth sensor, a gesture sensor, a gyroscope or gyro sensor, an air pressure sensor, a magnetic sensor or magnetometer, an acceleration sensor or accelerometer, a grip sensor, a proximity sensor, a color sensor (such as a red green blue (RGB) sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, or a fingerprint sensor. Moreover, the sensor(s) 180 can include one or more position sensors, such as an inertial measurement unit that can include one or more accelerometers, gyroscopes, and other components. In addition, the sensor(s) 180 can include a control circuit for controlling at least one of the sensors included here. Any of these sensor(s) 180 can be located within the electronic device 101.

In some embodiments, the electronic device 101 can be a wearable device or an electronic device-mountable wearable device (such as an HMD). For example, the electronic device 101 may represent an XR wearable device, such as a headset or smart eyeglasses. In other embodiments, the first external electronic device 102 or the second external electronic device 104 can be a wearable device or an electronic device-mountable wearable device (such as an HMD). In those other embodiments, when the electronic device 101 is mounted in the electronic device 102 (such as the HMD), the electronic device 101 can communicate with the electronic device 102 through the communication interface 170. The electronic device 101 can be directly connected with the electronic device 102 to communicate with the electronic device 102 without involving with a separate network.

The first and second external electronic devices 102 and 104 and the server 106 each can be a device of the same or a different type from the electronic device 101. According to certain embodiments of this disclosure, the server 106 includes a group of one or more servers. Also, according to certain embodiments of this disclosure, all or some of the operations executed on the electronic device 101 can be executed on another or multiple other electronic devices (such as the electronic devices 102 and 104 or server 106). Further, according to certain embodiments of this disclosure, when the electronic device 101 should perform some function or service automatically or at a request, the electronic device 101, instead of executing the function or service on its own or additionally, can request another device (such as electronic devices 102 and 104 or server 106) to perform at least some functions associated therewith. The other electronic device (such as electronic devices 102 and 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the external electronic device 104 or server 106 via the network 162 or 164, the electronic device 101 may be independently operated without a separate communication function according to some embodiments of this disclosure.

The server 106 can include the same or similar components as the electronic device 101 (or a suitable subset thereof). The server 106 can support to drive the electronic device 101 by performing at least one of operations (or functions) implemented on the electronic device 101. For example, the server 106 can include a processing module or processor that may support the processing device 120 implemented in the electronic device 101. As described below, the server 106 may perform one or more functions related to online rectification of a stereo pair of image frames in XR or other applications.

Although FIG. 1 illustrates one example of a network configuration 100 including an electronic device 101, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

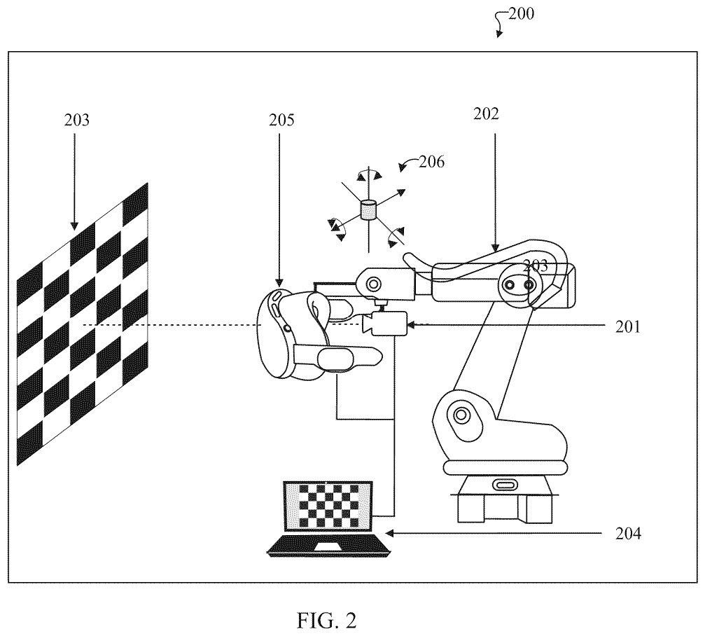

FIG. 2 illustrates an example platform 200 for offline see-through camera calibration. The platform 200 includes a proxy camera 201, a movable device 202 (such as a robotic arm), an object 203 (such as a checkerboard), and a stereoscopic calibrator 204 (such as a computing device). A VST headset device 205 (such as the electronic device 101 of FIG. 1) includes a stereoscopic see-through camera pair, one for a left view and another for a right view. For example, the stereoscopic see-through camera pair may represent a pair of imaging sensors 180 of the electronic device 101. The platform 200 may be available at the manufacturer of the VST headset device 205 to calibrate the stereo camera pair at manufacturing or at other specialized facilities to which the VST headset device 205 may be shipped for calibration offline.

The proxy camera 201 and the VST headset device 205 can be mounted on the movable device 202. In some cases, the proxy camera 201 can be installed at the eye viewpoint of the VST headset device 205. The proxy camera 201 and the VST headset device 205 can be connected to the stereoscopic calibrator 204. The movable device 202 can move the VST headset device 205 in a designed motion trajectory, such as with six degrees of freedom 206, to allow the VST headset device 205 to capture image frames of the object 203. The proxy camera 201 can collect the image frames of the object 203 by seeing through the VST headset device 205 and store the image frames to the stereoscopic calibrator 204. The stereoscopic calibrator 204 can compute camera calibration parameters, such as intrinsic parameters (like distortion coefficients) and extrinsic parameters (like rotation matrices and translation vectors) between the see-through camera pair.

As can be seen here, this offline stereo calibration and rectification of the see-through cameras can be inconvenient and inefficient. When performed after manufacture and shipment, this process requires users to ship their VST headset devices to specialized or designated platforms for stereoscopic calibration and rectification.

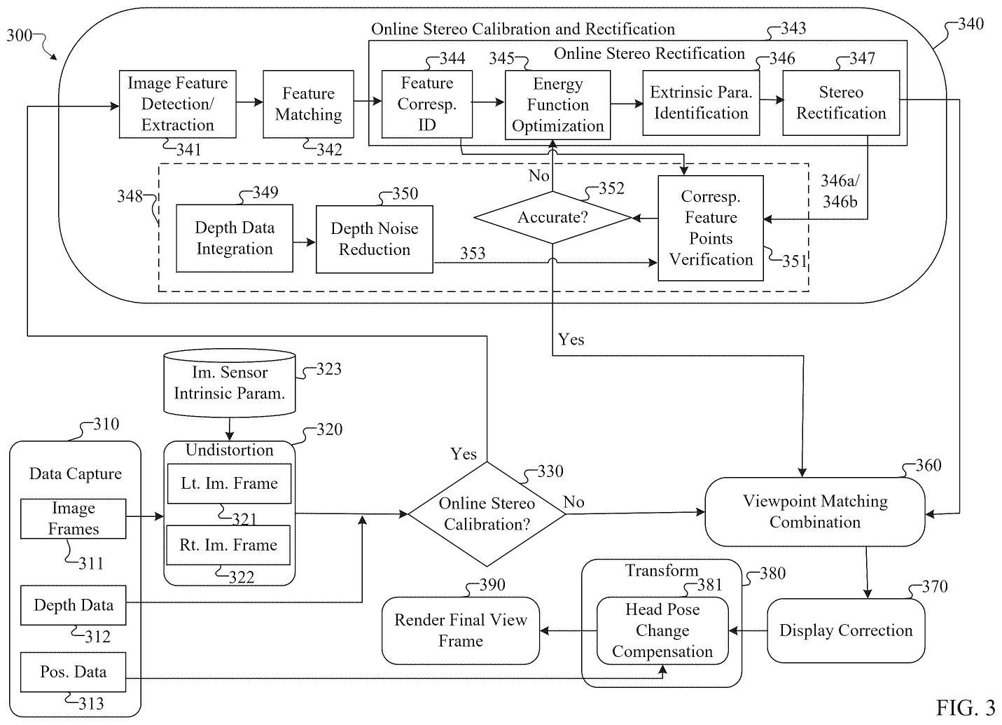

FIG. 3 illustrates an example pipeline 300 for online rectification of a stereo pair of image frames in XR or other applications in accordance with this disclosure. For ease of explanation, the pipeline 300 shown in FIG. 3 is described as being performed using the electronic device 101 in the network configuration 100 shown in FIG. 1. However, the pipeline 300 shown in FIG. 3 may be performed using any other suitable device(s) and in any other suitable system(s).

As shown in FIG. 3, the pipeline 300 includes a data collection operation 310, an undistortion operation 320, a determination operation 330, an online stereo calibration and rectification operation 340, a viewpoint matching operation 360, a display correction operation 370, a transform operation 380, and a frame rendering operation 390. The data collection operation 310 generally operates to obtain image frames and associated data and includes an image frame capture operation 311, a depth data capture operation 312, and a head pose data capture operation 313.

The image frame capture operation 311 generally operates to capture left and right image frames of a scene. Each left image frame and its corresponding right image frame form a stereo pair of image frames. Each image frame may be captured by the electronic device 101, such as by using one or more imaging sensors 180 of the electronic device 101. In some cases, each captured image frame may represent an image frame of a scene captured by a forward-facing or other imaging sensor(s) 180 of the electronic device 101. Each image frame can have any suitable size, shape, and resolution and include image data in any suitable domain. As particular examples, each image frame may include RGB image data, YUV image data, or Bayer or other raw image data.

The depth data capture operation 312 generally operates to obtain depth data associated with each image frame. The depth data may be obtained from any suitable source(s), such as from one or more depth sensors like at least one time-of-flight (ToF) sensor, light detection and ranging sensor (LiDAR), or stereo vision sensor. In some cases, for example, the depth data may include time measurements of light pulses returning to a ToF sensor, distorted light patterns, or RGB images from slightly different angles.

The head pose data capture operation 313 generally operates to obtain information related to the pose of a user's head while the electronic device 101 is being used. The head pose information may be obtained from any suitable source(s), such as from one or more positional sensors like at least one IMU. In some cases, the head pose information may be expressed using six degrees of freedom, such as three translation values and three rotation values. The three translation values may identify the movement of the user's head along three orthogonal axes, and the three rotation values may identify rotation of the user's head about the three orthogonal axes. Note, however, that the head pose information may have any other suitable form.

The undistortion operation 320 generally operates to undistort the captured left and right image frames using respective intrinsic parameters 323 of the see-through camera pair. The intrinsic parameters generally describe how the stereo camera pair perceives objects and can include a focal length, a principal point, and distortion coefficients. A focal length may indicate the degree of the camera's telescopic strength (such as an amount of zooming). A principal point may indicate the center of the image on which the cameras' optical points are focused. The distortion coefficients may indicate an extent of lens distortions (such as image warping caused by a lens of the camera). The intrinsic parameters 323 may be obtained for each imaging sensor of the see-through camera pair. In some embodiments, the undistortion operation 320 may include the processing device 120 of the electronic device 101 correcting distortions in the captured left image using the intrinsic parameters 323 of the left imaging sensor and the captured right image using the intrinsic parameters 323 of the right imaging sensor. Since the processing device 120 can learn the intrinsic parameters 323 for each camera, the processing device 120 can identify the extent of the lens distortions and correct image distortions caused by the lens distortions, such as by moving pixels so that straights lines appear straight.

The online stereo calibration and rectification determination operation 340 generally operates to determine whether stereo calibration and rectification needs to be made based on the undistorted image frames and the depth data. This may include the processing device 120 determining whether the stereo calibration and rectification is needed autonomously or based on a user request.

In response to a determination that the stereo calibration and rectification is needed, the online stereo calibration and rectification operation 340 generally operates to perform online stereo calibration and rectification on each stereo pair of image frames. The online stereo calibration and rectification operation 340 includes a feature extraction operation 341, a feature matching operation 342, and an online stereo rectification operation 343. The feature extraction operation 341 generally operates to detect one or more common image features and extract left and right image features associated with each common image feature from left and right image frames. For example, the processing device 120 may identify a corner of a checkerboard from the left and right image frames and extract left and right image features associated with the corner. The feature matching operation 342 generally operates to determine if the left and right image features match. In the example of the checkerboard, the processing device 120 may determine if the left and right image features that are associated with the corner match. If the left and right image features match, the online stereo rectification operation 343 is performed. If the left and right image features do not match, different left and right image features can be extracted, and the feature matching operation 342 may be performed using the different left and right image features.

The online stereo rectification operation 343 generally operates to perform stereo rectification using extrinsic parameters of the stereo camera pair and includes a feature correspondence identification operation 344, an energy function optimization operation 345, an extrinsic parameter identification operation 346, and a stereo rectification operation 347. The feature correspondence identification operation 344 generally operates to identify a feature correspondence in the matched left and right image features. This may include the processing device 120 identifying correspondence feature points in the matched image features. For example, the processing device 120 may identify a corresponding left image feature point pₗ and a corresponding right image feature point pᵣ associated with a center point P in the left and right image features.

The energy function optimization operation 345 generally operates to optimize an energy function E by minimizing an energy score thereof. This may include the processing device 120 iteratively computing the relative positions and orientations of the left and right imaging sensors, where each iteration results in a lower energy score from the previous iteration, until the energy score has reached a minimum threshold. In some embodiments, the energy function E can be built with the feature correspondences and the camera positions, such as in the following manner.

$${min}_{R , t} E = arg min ( {p}_{l} , {p}_{r} , {R}_{l} , {R}_{r} , {t}_{l} , {t}_{r} ) \qquad ( 1 )$$

Here, pₗ(x, y), pᵣ(x, y) are the correspondence left feature point and the correspondence right feature point, respectively, (Rₗ, tₗ) is the rotation and translation of the left camera, and (Rᵣ, tᵣ) is the rotation and translation of the right camera.

The extrinsic parameter identification operation 346 generally operates to identify stereo rectification extrinsic parameters. This may include the processing device 120 computing the stereo rectification extrinsic parameters from the positions of the left imaging sensor and the right imaging sensor. In some embodiments, the stereo rectification extrinsic parameters may be defined as follows.

$$\{ \begin{matrix}R = {R}_{r}^{- 1} {R}_{l} \\ t = - {r}_{r , 1}\end{matrix}$$

Here, R is the rotation matrix between the left and right imaging sensors, and t is the translation vector between the left and right imaging sensors. In some cases, the rotation matrix may be defined as follows.

$$R = [ \begin{matrix}{r}_{r , 1} & {r}_{r , 2} & {r}_{r , 3}\end{matrix} ] \qquad ( 2 )$$

Here, r_{r,1}, r_{r,2}, r_{r,3} are rotation vectors. Also, in some cases, the translation vector may be defined as follows.

$$t = {[ \begin{matrix}{t}_{x} & {t}_{y} & {t}_{z}\end{matrix} ]}^{T} \qquad ( 3 )$$

Here, tₓ, t_{y}, t_{z} are rotations in the x, y, z directions, respectively. Upon optimization of the energy function, stereo rectification extrinsic parameters 346a can be obtained, which can be expressed as (Rₗ, Rᵣ, tₗ, tᵣ)→(R, t).

The stereo rectification operation 347 generally operates to rectify each stereo pair of the image frames using the corresponding stereo rectification extrinsic parameters 346a on-the-fly (such as online). This may include the processing device 120 aligning epipolar lines horizontally such that the corresponding feature points are on the same row (such as have the same pixel coordinates). For example, the processing device 120 may use the rotation matrix to curve or warp one or both image frames in a pair such that the rectified stereo pair of the image frames appear as if they have been captured by the user's eyes.

In some embodiments, the online stereo rectification operation 343 may also include an extrinsic parameter refinement operation 348. The extrinsic parameter refinement operation 348 generally operates to refine the stereo rectification extrinsic parameters 346a and includes a depth data integration operation 349, a depth noise reduction operation 350, a correspondence feature points verification operation 351, and an accuracy determination operation 352. The depth data integration operation 349 generally operates to acquire depth data, such as from the extrinsic parameters or one or more depth sensors 180 (such as LiDAR). This may include the processing device 120 computing first corresponding image feature points

$$( {p}_{l}^{1} , {p}_{r}^{1} )$$

from the stereo rectification extrinsic parameters. This means that, given an image feature point

$${p}_{l}^{1}$$

in one image of the image pair, the correspondence feature point

$${p}_{r}^{1}$$

in the other image of the image pair can be computed with stereo rectification extrinsic parameters. In some cases, this may be expressed as follows.

$${p}_{r}^{1} ← ℱ ( R , t , {p}_{l}^{1} ) \qquad ( 4 )$$

Here, (R, t) is the rotation matrix and translation vector of the stereo rectification extrinsic parameters. The processing device 120 may further obtain depth data from the depth sensor(s).

The depth noise reduction operation 350 generally operates to fuse the depth data captured by the depth sensor(s) and other sensors 180. This may include the processing device 120 integrating the fused depth data into a complete 3D data map. For example, the processing device 120 may combine a noisy stereo depth map (such as a bumpy wall) with a smooth LiDAR map to obtain a clearer 3D depth map (such as a smooth wall).

The correspondence feature points verification operation 351 generally operates to identify second correspondence feature points using reduced noise depth data 353 and to verify the rectified correspondence feature points

$$( {p}_{l}^{1} , {p}_{r}^{1} )$$

obtained from the stereo rectification extrinsic parameters 346a with the second correspondence feature points. This may include the processing device 120 computing the second correspondence feature points from a depth equation, which in some cases may be defined as follows.

$$d = \frac{fB}{{x}_{r} - {x}_{l}} \qquad ( 5 )$$

Here, d is the depth, f is the focal length, B is the base line, xₗ is the left point pₗ, and xᵣ is the right point pᵣ. Since the left and right image frames in the image pair are rectified, the following relationship can be known.

$${y}_{l} = {y}_{r} \qquad ( 6 )$$

The second correspondence feature points

$$( {p}_{l}^{2} , {p}_{r}^{2} )$$

can be obtained from Equation (5), which can be written as follows.

$${x}_{r} - {x}_{l} = \frac{fB}{d} \qquad ( 7 )$$

The processing device 120 may verify the second correspondence feature points with corresponding depths. For example, the processing device 120 may compare the second correspondence feature points

$$( {p}_{l}^{2} , {p}_{r}^{2} )$$

to the rectified correspondence feature points

$$( {p}_{l}^{1} , {p}_{r}^{1} )$$

and obtain differences of the correspondence feature points

$$( {p}_{l}^{1} , {p}_{r}^{1} ) , ( {p}_{l}^{2} , {p}_{r}^{2} )$$

between Equation (4) and Equation (7). If the differences are within an accuracy threshold, the rectified correspondence feature points may be determined to be accurate and reliable. The accuracy determination operation 352 generally operates to determine if the differences between the first and second correspondence feature points

$$( {p}_{l}^{1} , {p}_{r}^{1} ) , ( {p}_{l}^{2} , {p}_{r}^{2} )$$

falls within the accuracy threshold.

If the accuracy is within the accuracy threshold, the prior stereo rectification operation is successful, and the viewpoint matching operation 360 can be performed. If the accuracy falls outside of the accuracy threshold, the energy function optimization operation 345 operates to refine the stereo rectification extrinsic parameters 346a by optimizing the energy function. This may include the processing device 120 minimizing the energy score of the energy function based on the stereo rectification extrinsic parameters 346a. The extrinsic parameter identification operation 346 identifies the refined stereo rectification extrinsic parameters 346b, and the stereo rectification operation 347 performs another online stereo rectification using the refined stereo rectification extrinsic parameters 346b. The correspondence feature points verification operation 351 identifies third correspondence feature points using the reduced noise depth data 353, verifies the third correspondence features points with corresponding depths, compares the third correspondence features points to the rectified refined correspondence feature points, and obtains differences between the third correspondence feature points and the rectified refined correspondence feature points. The accuracy determination operation 352 determines whether the refined stereo rectification extrinsic parameters are accurate and reliable based on the differences as compared to the accuracy threshold. While one round of refinement should be sufficient, one or more additional rounds of further refinements may be performed until the accuracy threshold is satisfied.

The viewpoint matching operation 360 generally operates to perform viewpoint matching and may follow the stereo rectification operation 347, a determination that stereo calibration and rectification is not needed at the determination operation 330, or a determination that difference between the correspondence features points based on depth data and the stereo rectification extrinsic parameters is within the accuracy threshold. The viewpoint matching operation 360 may include the processing device 120 transforming the rectified stereo pair of image frames to match one or more user eye viewpoints and generate one or more viewpoint matched frames. The viewpoint matching operation 360 can be used to compensate for things like registration and parallax errors, which may be caused by factors like differences between the positions of the imaging sensors and the user's eyes. As particular examples, the viewpoint mapping operation 360 may identify and apply a rotation and/or a translation to each image frame in order to compensate for these or other types of issues. Ideally, the transformations give the appearance that the image frames captured at the locations of the imaging sensors were actually captured at the locations of the user's eyes. Often times, the rotation and/or translation can be derived mathematically based on the position and angle of each imaging sensor and the expected or actual positions of the user's eyes. In some cases, the transformations are static (since these positions and angles will not change), allowing the transformations to be applied quickly.

The display correction operation 370 generally operates to correct for display distortions. This may include the processing device 120 correcting display lens distortions and chromatic aberrations. The display lens correction and the chromatic aberration correction can be used to compensate for distortions created in displayed images, such as geometric distortions and chromatic aberrations created by display lenses (which are lenses positioned between the user's eyes and one or more display panels forming the display(s) 160).

The transform operation 380 generally operates to apply one or more transformations to each rectified stereo pair of the image frames in order to generate one or more transformed image frames. For example, the transform operation 380 may include a head pose change compensation operation 381, which generally operates to apply a transformation to reproject each of the transformed image frames based on a head pose change of the user (if necessary). In many cases, for instance, image frames will be captured at one time and rendered images will be subsequently displayed to the user some amount of time later, and it is possible for the user to move his or her head during this intervening time period. The head pose change compensation operation 381 can therefore be used to estimate, for each image frame, what the user's head pose will likely be when a rendered image based on that image frame will be displayed to the user. In some cases, the head pose change compensation operation 381 may obtain inputs from at least one IMU, head pose tracking camera, or other position sensor(s) 180 of the electronic device 101 while image frames are being captured using the imaging sensors 180. The head pose change compensation operation 381 can use this information to estimate what the user's head pose will likely be when rendered images are actually displayed to the user.

The frame rendering operation 390 generally operates create final views of the scene captured in the transformed image frames generated by the transform operation 380. The frame rendering operation 390 can also render the final views for presentation to the user of the electronic device 101. For example, the frame rendering operation 390 may process the transformed image frames and perform any additional refinements or modifications needed or desired, and the resulting images can represent the final views of the scene. For instance, a 3D-to-2D warping can be used to warp the final views of the scene into 2D images. The frame rendering operation 390 can also present the rendered images to the user. The frame rendering operation 390 can render the images into a form suitable for transmission to at least one display 160 and can initiate display of the rendered images, such as by providing the rendered images to one or more displays 160. In some cases, there may be a single display 160 on which the rendered images are presented for viewing by the user, such as where each eye of the user views a different portion of the display 160. In other cases, there may be separate displays 160 on which the rendered images are presented for viewing by the user, such as one display 160 for each of the user's eyes.

The pipeline 300 allows on-the-fly stereo rectification of stereo pairs of image frames, refinement of extrinsic parameters based on prior stereo rectification and depth data collected from depth sensors, and combining online stereo rectification with viewpoint matching. The pipeline 300 therefore significantly improves efficiency, convenience, and user experience. The pipeline 300 also reduces computational loads and complexity compared to existing offline stereo rectification approaches.

Although FIG. 3 illustrates one example of a pipeline 300 for online stereo rectification of a stereo pair of image frames in XR or other applications, various changes may be made to FIG. 3. For example, various components or operations in FIG. 3 may be combined, further subdivided, replicated, omitted, or rearranged and additional components or operations may be added according to particular needs.

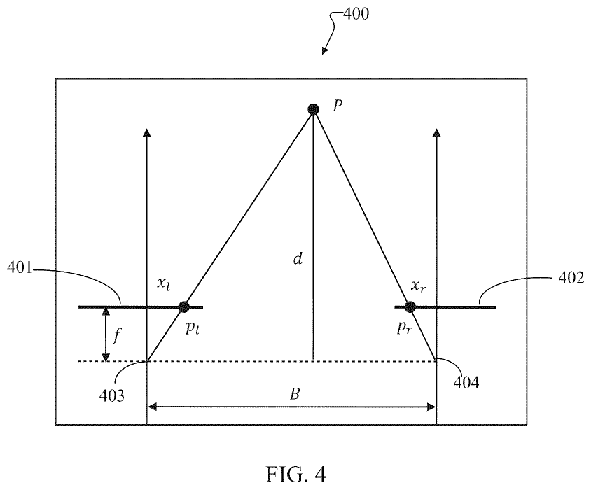

FIG. 4 illustrates an example relationship 400 between depth d and correspondence points on a rectified stereo pair 401, 402 of image frames in accordance with this disclosure. For ease of explanation, the relationship 400 shown in FIG. 4 is described as being used by the electronic device 101 in the network configuration 100 shown in FIG. 1, such as for the extrinsic parameter refinement operation 348 of the online stereo calibration and rectification operation 340 of FIG. 3. However, the relationship 400 shown in FIG. 4 may be used by any other suitable device(s) and in any other suitable system(s).

As shown in FIG. 4, the center point P of a captured scene has a correspondence feature point pₗ of a rectified left image frame 401 and a correspondence feature points pᵣ of a rectified right image frame 402. The correspondence feature points pₗ, pᵣ have horizontal shifts xₗ, xᵣ from the x-coordinate of the center point P. Since the left and right image frames 401,402 are rectified, the correspondence image features points pₗ, pᵣ are on the same row (yₗ=yᵣ).

Depths can be computed using the horizontal disparity (xᵣ−xₗ), the focal length f, and the baseline B as shown in Equation (5) above. The correspondence feature points pₗ, pᵣ can be obtained using the depth data using Equations (5) and (7) above. The differences of these correspondence feature points pₗ, pᵣ and the correspondence feature points

$$( {p}_{l}^{1} , {p}_{r}^{1} )$$

computed from the stereo calibration extrinsic parameters (R, t) can be used for refining the stereo calibration extrinsic parameters (R, t).

If the differences between the correspondence feature points pₗ, pᵣ and the correspondence feature points

$$( {p}_{l}^{1} , {p}_{r}^{1} )$$

are outside of the accuracy threshold, the stereo calibration extrinsic parameters (R, t) can be refined by optimizing the energy function at the energy function optimization operation 345. With the refined stereo calibration extrinsic parameters, testing correspondence feature points can be selected and rectified using the correspondence feature points pₗ, pᵣ. Moreover, the depth data captured by the depth sensor(s) and the depths from different sources can be integrated at the depth data integration operation 349, and noise can be reduced from the integrated depths at the depth noise reduction operation 350. Using the integrated depths (such as in the form of an integrated depth map), the correspondence feature points pₗ, pᵣ can be verified with corresponding depths at the correspondence feature points verification operation 351. The accuracy of the verified correspondence feature points pₗ, pᵣ is determined at the accuracy determination operation 352. If the accuracy is below the accuracy threshold, further computation and refinement of the stereo calibration extrinsic parameters can be repeated.

Although FIG. 4 illustrates one example of a relationship 400 between depth d and correspondence points on a rectified stereo pair 401, 402 of image frames, various changes may be made to FIG. 4. For example, other relationships may be defined between depths and correspondence points, or other relationships may be used to define and refine correspondence points.

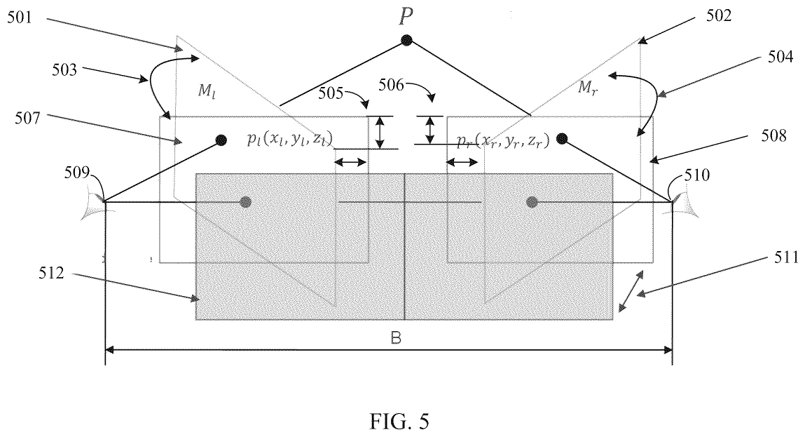

FIG. 5 illustrates an example diagram 500 of online stereo rectification 503-506 and viewpoint matching 511 in accordance with this disclosure. For ease of explanation, the online stereo rectification and viewpoint matching operations are described using the electronic device 101 in the network configuration 100 shown in FIG. 1. For example, the online stereo rectification may represent or be similar to the online stereo rectification operation 343 of FIG. 3, and the viewpoint matching operation 511 may represent or be similar to the viewpoint matching operation 360 of FIG. 3. However, the operations shown in FIG. 5 may be performed using any other suitable device(s) and in any other suitable system(s).

As shown in FIG. 5, a 3D center point P in a captured scene has correspondence feature points pₗ, pᵣ in the left and right image frames (Mₗ, Mᵣ) 501, 502. The left and right image frames 501, 502 are rectified by rotating 503, 504 and translating 505, 506 to form a rectified stereo pair 507, 509 of image frames. The images of the rectified stereo pair 507, 509 have horizontally-aligned epipolar lines so as to mimic the stereoscopic views that human eyes capture.

However, the optical viewpoints of the user's eyes are not aligned with the correspondence feature points such that the user may experience discomfort. That is, the left and right eyes see the center point at optical correspondence feature points 513, 514, while the rectified left and right image frames see the center point at the correspondence features points pₗ, pᵣ. To improve the user experience, the viewpoint matching operation 511 can be performed. This may include the processing device 120 of the electronic device 101 transforming the rectified stereo pair 507, 508 of image frames to match one or more user eye viewpoints 509, 510 and generate one or more viewpoint matched frames 512. Thus, the stereo rectification 503-506 and the viewpoint matching 511 are combined, thereby reducing computational loads and complexity. The one or more viewpoint matched frames 512 are now aligned with the user's left and right optical centers 509, 510, and the 3D point P will appear normal and natural.

Although FIG. 5 illustrates one example of a diagram 500 of online stereo rectification 503-506 and viewpoint matching 511, various changes may be made to FIG. 5. For example, the online stereo rectification and viewpoint matching of FIG. 5 are for illustrative purposes only and can change as appropriate.

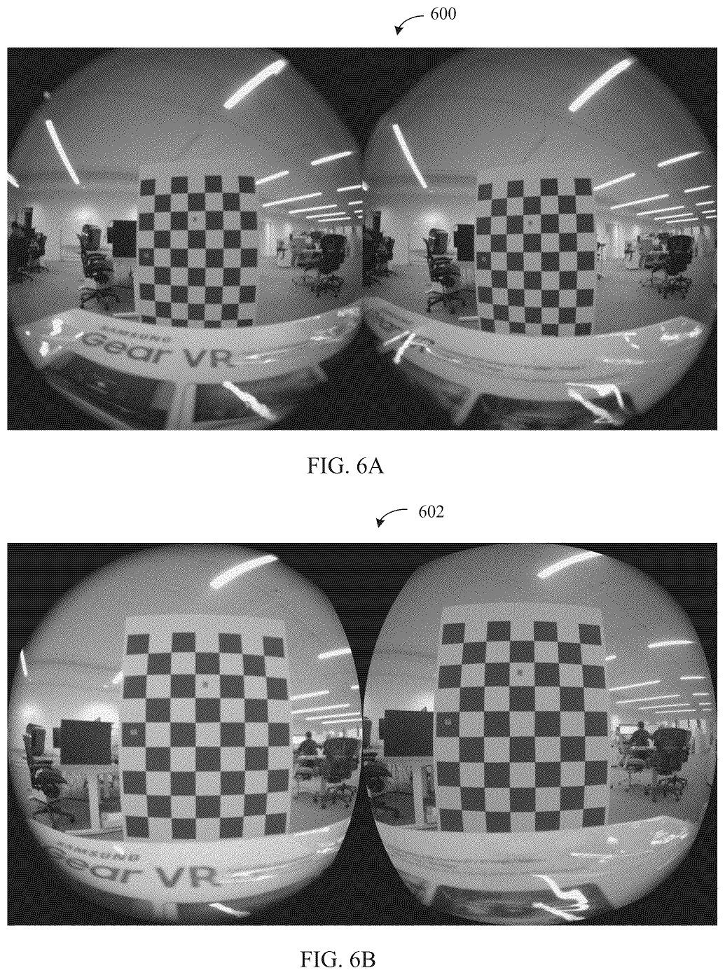

FIGS. 6A and 6B illustrate a raw stereo pair of image frames and a rectified stereo pair of image frames using online stereo rectification, respectively, in accordance with this disclosure. More specifically, FIG. 6A illustrates an example stereo pair of output images 600 generated without using online stereo rectification. As can be seen here, the output images 600 appear misaligned and unbalanced. That is, the corresponding points on the checkerboards appear to be on different y-coordinates and have different perspectives. This may cause discomfort to a user viewing the output images 600.

FIG. 6B illustrates an example stereo pair of output images 602 generated using the techniques described above. As can be seen here, the resulting output images 602 provide much better results compared to the output images 600. Among other reasons, this is because the electronic device 101 is able to perform stereo rectification on-the-fly to generate aligned and balanced images. This can result in significant improvements in the quality of the resulting output images, thereby improving the user experience.

Although FIGS. 6A and 6B illustrate one example of a raw stereo pair of image frames and a rectified stereo pair of image frames using online stereo rectification, respectively, various changes may be made to FIGS. 6and6. For example, FIGS. 6A and 6B are merely meant to illustrate one example of a type of benefit that might be obtained using the techniques of this disclosure. The specific results that are obtained in any given situation can vary based on the circumstances and based on the specific implementation of the techniques described in this disclosure.

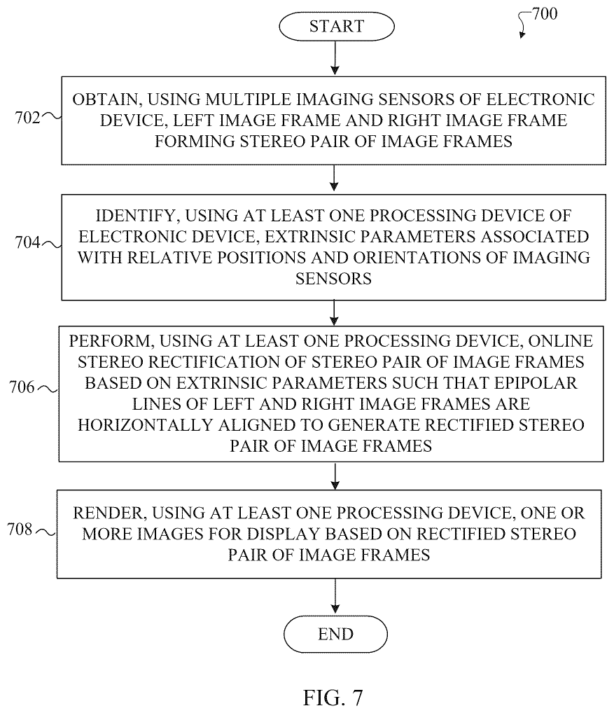

FIG. 7 illustrates an example method 700 for online stereo rectification in accordance with this disclosure. For ease of explanation, the method 700 shown in FIG. 7 is described as being performed using the electronic device 101 in the network configuration 100 shown in FIG. 1, where the electronic device 101 may implement the pipeline 300 shown in FIG. 3. However, the method 700 may be performed using any other suitable device(s) and in any other suitable system(s), and the method 700 may be implemented using any other suitable pipeline(s) or architecture(s) designed in accordance with this disclosure.

As shown in FIG. 7, at step 702, a left image frame and a right image frame forming a stereo pair of image frames are obtained. This may include, for example, the processing device 120 of the electronic device 101 obtaining the image frames using multiple imaging sensors 180 of the electronic device 101.

At step 704, extrinsic parameters associated with relative positions and orientations of the imaging sensors are identified. This may include, for example, the processing device 120 of the electronic device 101 identifying at least one common image feature in the left and right image frames, extracting left and right image features associated with each common image feature from the left and right image frames, and determining if the left and right image features match. In response to a determination that the left and right image features match, a feature correspondence between the left and right image frames may be obtained, and an energy function associated with the feature correspondence may be optimized. The extrinsic parameters may be identified based on the optimized energy function.

At step 706, an online stereo rectification of the stereo pair of image frames is performed based on the extrinsic parameters such that epipolar lines of the left and right image frames are horizontally aligned to generate a rectified stereo pair of image frames. This may include, for example, the processing device 120 of the electronic device 101 identifying first correspondence feature points using the extrinsic parameters, identifying second correspondence feature points using depth data associated with the stereo pair of image frames, determining that a difference between the first and second correspondence feature points is greater than a threshold, refining the extrinsic parameters by further optimizing the energy function based on the difference, and performing online stereo rectification of the rectified stereo pair of image frames based on the refined extrinsic parameters. This may also include the processing device 120 of the electronic device 101 performing viewpoint matching by transforming the rectified stereo pair of image frames to match one or more user eye viewpoints and generate one or more viewpoint matched frames. In some cases, the extrinsic parameters may include a rotation matrix and a translation vector. Also, in some cases, the online stereo rectification may be performed automatically based on the extrinsic parameters or based on a user request.

At step 708, one or more images are rendered for display based on the rectified stereo pair of image frames. This may include, for example, the processing device 120 of the electronic device 101 applying one or more transformations to the rectified stereo pair of image frames and rendering one or more resulting transformed image frames.

Although FIG. 7 illustrates one example of a method 700 for online stereo rectification of a stereo pair of image frames, various changes may be made to FIG. 7. For example, while shown as a series of steps, various steps in FIG. 7 may overlap, occur in parallel, occur in a different order, or occur any number of times (including zero times).

It should be noted that the functions shown in the figures or described above can be implemented in an electronic device 101, 102, 104, server 106, or other device(s) in any suitable manner. For example, in some embodiments, at least some of the functions shown in the figures or described above can be implemented or supported using one or more software applications or other software instructions that are executed by the processing device 120 of the electronic device 101, 102, 104, server 106, or other device(s). In other embodiments, at least some of the functions shown in the figures or described above can be implemented or supported using dedicated hardware components. In general, the functions shown in the figures or described above can be performed using any suitable hardware or any suitable combination of hardware and software/firmware instructions. Also, the functions shown in the figures or described above can be performed by a single device or by multiple devices.

Although this disclosure has been described with example embodiments, various changes and modifications may be suggested to one skilled in the art. It is intended that this disclosure encompass such changes and modifications as fall within the scope of the appended claims.

What is claimed is:

1. A method comprising:
obtaining, using multiple imaging sensors of an electronic device, a left image frame and a right image frame forming a stereo pair of image frames;
identifying, using at least one processing device of the electronic device, extrinsic parameters associated with relative positions and orientations of the imaging sensors;
performing, using the at least one processing device, an online stereo rectification of the stereo pair of image frames based on the extrinsic parameters such that epipolar lines of the left and right image frames are horizontally aligned to generate a rectified stereo pair of image frames; and
rendering, using the at least one processing device, one or more images for display based on the rectified stereo pair of image frames.

2. The method of claim 1, wherein identifying the extrinsic parameters comprises:
identifying a common image feature in the left and right image frames;
extracting left and right image features associated with the common image feature from the left and right image frames;
determining if the left and right image features match;
in response to a determination that the left and right image features match, obtaining a feature correspondence between the left and right image frames;
optimizing an energy function associated with the feature correspondence; and
identifying the extrinsic parameters based on the optimized energy function.

3. The method of claim 2, wherein performing the online stereo rectification of the stereo pair of image frames comprises:
identifying first correspondence feature points using the extrinsic parameters;
identifying second correspondence feature points using depth data associated with the stereo pair of image frames;
determining that a difference between the first and second correspondence feature points is greater than a threshold;
refining the extrinsic parameters by further optimizing the energy function based on the difference; and
performing online stereo rectification of the rectified stereo pair of image frames based on the refined extrinsic parameters.

4. The method of claim 1, wherein performing the online stereo rectification comprises performing viewpoint matching by transforming the rectified stereo pair of image frames to match one or more user eye viewpoints and generate one or more viewpoint matched frames.

5. The method of claim 1, wherein the extrinsic parameters comprise a rotation matrix and a translation vector.

6. The method of claim 1, further comprising:
applying a transformation to the rectified stereo pair of image frames in order to generate one or more transformed image frames;
wherein rendering the one or more images for display comprises rendering the one or more transformed image frames.

7. The method of claim 1, wherein the online stereo rectification is performed automatically based on the extrinsic parameters or based on a user request.

8. An apparatus comprising:
multiple imaging sensors configured to obtain a left image frame and a right image frame forming a stereo pair of image frames; and
at least one processing device configured to:
identify extrinsic parameters associated with relative positions and orientations of the imaging sensors;
perform an online stereo rectification of the stereo pair of image frames based on the extrinsic parameters such that epipolar lines of the left and right image frames are horizontally aligned to generate a rectified stereo pair of image frames; and
render one or more images for display based on the rectified stereo pair of image frames.

9. The apparatus of claim 8, wherein, to identify the extrinsic parameters, the at least one processing device is configured to:
identify a common image feature in the left and right image frames;
extract left and right image features associated with the common image feature from the left and right image frames;
determine if the left and right image features match;
in response to a determination that the left and right image features match, obtain a feature correspondence between the left and right image frames;
optimize an energy function associated with the feature correspondence; and
identify the extrinsic parameters based on the optimized energy function.

10. The apparatus of claim 9, wherein, to perform the online stereo rectification, the at least one processing device is configured to:
identify first correspondence feature points using the extrinsic parameters;
identify second correspondence feature points using depth data associated with the stereo pair of image frames;
determine that a difference between the first and second correspondence feature points is greater than a threshold;
refine the extrinsic parameters by further optimizing the energy function based on the difference; and
perform online stereo rectification of the rectified stereo pair of image frames based on the refined extrinsic parameters.

11. The apparatus of claim 8, wherein, to perform the online stereo rectification, the at least one processing device is configured to perform viewpoint matching by transforming the rectified stereo pair of image frames to match one or more user eye viewpoints and generate one or more viewpoint matched frames.

12. The apparatus of claim 8, wherein the extrinsic parameters comprise a rotation matrix and a translation vector.

13. The apparatus of claim 8, wherein:
the at least one processing device is further configured to apply a transformation to the rectified stereo pair of image frames in order to generate one or more transformed image frames; and
to render the one or more images for display, the at least one processing device is configured to render the one or more transformed image frames.

14. The apparatus of claim 8, wherein the at least one processing device is configured to perform the online stereo rectification automatically based on the extrinsic parameters or based on a user request.

15. A non-transitory machine readable medium containing instructions that when executed cause at least one processor of an electronic device to:
obtain a left image frame and a right image frame forming a stereo pair of image frames using multiple imaging sensors;
identify extrinsic parameters associated with relative positions and orientations of the imaging sensors;
perform an online stereo rectification of the stereo pair of image frames based on the extrinsic parameters such that epipolar lines of the left and right image frames are horizontally aligned to generate a rectified stereo pair of image frames; and
render one or more images for display based on the rectified stereo pair of image frames.

16. The non-transitory machine readable medium of claim 15, wherein the instructions that when executed cause the at least one processor to identify the extrinsic parameters comprise instructions that when executed cause the at least one processor to:
identify a common image feature in the left and right image frames;
extract left and right image features associated with the common image feature from the left and right image frames;
determine if the left and right image features match;
in response to a determination that the left and right image features match, obtain a feature correspondence between the left and right image frames;
optimize an energy function associated with the feature correspondence; and
identify the extrinsic parameters based on the optimized energy function.

17. The non-transitory machine readable medium of claim 16, wherein the instructions that when executed cause the at least one processor to perform the online stereo rectification comprise instructions that when executed cause the at least one processor to:
identify first correspondence feature points using the extrinsic parameters;
identify second correspondence feature points using depth data associated with the stereo pair of image frames;
determine that a difference between the first and second correspondence feature points is greater than a threshold;
refine the extrinsic parameters by further optimizing the energy function based on the difference; and
perform online stereo rectification of the rectified stereo pair of image frames based on the refined extrinsic parameters.

18. The non-transitory machine readable medium of claim 15, wherein the instructions that when executed cause the at least one processor to perform the online stereo rectification comprise instructions that when executed cause the at least one processor to perform viewpoint matching by transforming the rectified stereo pair of image frames to match one or more user eye viewpoints and generate one or more viewpoint matched frames.

19. The non-transitory machine readable medium of claim 15, wherein the extrinsic parameters comprise a rotation matrix and a translation vector.

20. The non-transitory machine readable medium of claim 15, wherein the instructions when executed cause the at least one processor to perform the online stereo rectification automatically based on the extrinsic parameters or based on a user request.
